(19) United States
(12) Patent Application Publication
(10) Pub. No.: US 2015/0126055 A1
(43) Pub. Date: May 7, 2015

(54) CONNECTOR AND CONNECTOR CONNECTION STRUCTURE

(71) Applicants: FURUKAWA ELECTRIC CO., LTD., Tokyo (JP); FURUKAWA AUTOMOTIVE SYSTEMS, INC., Shiga (JP)

(72) Inventor: Haruki MORITA, Tokyo (JP)

(73) Assignees: FURUKAWA ELECTRIC CO., LTD., Tokyo (JP); FURUKAWA AUTOMOTIVE SYSTEMS, INC., Shiga (JP)

(21) Appl. No.: 14/594,824

(22) Filed: Jan. 12, 2015

Related U.S. Application Data
(63) Continuation of application No. PCT/JP2013/069217, filed on Jul. 12, 2013.

(30) Foreign Application Priority Data
Jul. 12, 2012 (JP) 2012-156159

(51) Int. Cl. H01R 24/28; H01R 13/658; H01R 13/622

(52) U.S. Cl. CPC H01R 24/28; H01R 13/622; H01R 13/658
USPC 439/323

(57) ABSTRACT

A connector includes a metal terminal part on which conductive wires exposed outside at an end of an electric cable are pressure-contacted; a housing for accommodating the end of the electric cable and the metal terminal part; and a tube-like metal cover for covering the housing and fixing the housing to an electric device M. The housing has an electric cable insertion hole through which the electric cable is insertable. The housing includes an engageable claw as position restriction means for restricting relative positions of the housing and the metal cover. The engageable claw is restricted, by the electric cable inserted into the electric cable insertion hole, from being displaced.

### CROSS-REFERENCE TO RELATED APPLICATIONS

This application is a continuation application of PCT International Application No. PCT/JP2013/069217 filed Jul. 12, 2013, which claims priority to Japanese Application No. 2012-156159 filed Jul. 12, 2012, both of which are herein incorporated by reference in their entirety for all purposes.

### TECHNICAL FIELD

The present invention relates to a connector which can be assembled with certainty with a simple structure while having a reduced number of components, and a connector connection structure including the same.

### BACKGROUND ART

Conventionally known connectors, for connecting an electric cable for supplying electricity of a large current and a high voltage to an input/output terminal of an electric device such as a motor mounted on an electric vehicle or the like, are water-proof and oil-proof and shield electromagnetic waves in order to protect electronic components in the vicinity thereof against electromagnetic noise released by the electric cable.

Patent Document 1 discloses, among such connectors, a connector including a metal cover formed of a metal shell and a shield stopper and also including a resin housing equipped with a metal terminal part. The housing is accommodated and fixed in an accommodation space inside the metal cover.

The metal cover of the connector disclosed in Patent Document 1 has the following structure. The shell and the shield stopper each have a flange, which has a bolt hole. The flanges are tightened together by a bolt which is inserted into the bolt holes to form the metal cover. The housing equipped with the metal terminal part is held by the two metal components (shell and shield stopper) to be accommodated in the metal cover.

However, the connector disclosed in Patent Document 1 requires the two metal components, namely, the shell and the shield stopper, which undesirably increases the number of components. In addition, the production of the connector requires the step of tightening the shell and the shield stopper by a bolt, which undesirably complicates the process of production.

### CITATION LIST

### Patent Literature

Patent Document 1: Japanese Laid-Open Patent Publication No. 2004-119047

### SUMMARY OF INVENTION

### Technical Problem

The present invention has an object of providing a connector which can be assembled with certainty with a simple structure while having a reduced number of components, and a connector connection structure including the same.

### Solution To Problem

The present invention is directed to a connector for connecting an electric cable to an electric device having an insertion opening provided for electric cable connection. The connector includes a metal terminal part on which conductive wires exposed outside at an end of the electric cable are pressure-contacted; a housing for accommodating the end of the electric cable and the metal terminal part; and a tube-like cover member for covering the housing and fixing the housing to the electric device. The housing has an electric cable insertion hole through which the electric cable is insertable; and the housing includes position restriction means for restricting relative positions of the housing and the cover member, the position restriction means being restricted, by the electric cable inserted into the electric cable insertion hole, from being displaced. The present invention is also directed to a connector connection structure including a connector having the above-described structure; and an insertion opening of an electric device. The connector is inserted into the insertion opening to connect the electric device and the electric cable(s) to each other.

According to the above, the connector can be assembled with certainty with a simple structure while having a reduced number of components.

This will be described in more detail. The cover member, which is tube-like, can be formed of a single component. This decreases the number of components of the connector. In addition, the electric cable inserted into the electric cable insertion hole is used to restrict the position restriction means from being displaced. Therefore, the relative positions of the housing and the cover member are restricted with no use of any additional bolt or the like. This decreases the number of components of the connector, and also makes the troublesome work of bolt tightening or the like unnecessary. Therefore, the connector can be assembled with certainty with a simple structure.

In an embodiment of the present invention, an outer circumferential surface of an insulting cover of the electric cable may be in contact with a wall of the electric cable insertion hole.

According to the above, the electric cable can be put into contact with the wall of the electric cable insertion hole with no gap. This allows the electric cable to restrict, with more certainty, the position restriction means from being displaced.

In an embodiment of the present invention, the housing may be formed of a flexible resin; the position restriction means may be an engageable member integrally formed in the housing, the engageable member being engageable with, and stopping, an edge of the cover member to restrict the relative positions of the housing and the cover member; the engageable member may be provided at an end of the electric cable insertion hole in a direction in which the electric cable is insertable; and the engageable member may be displaceable toward a center of the electric cable insertion hole in a radial direction thereof.

According to the above, the edge of the cover member can be put into engagement with, and stopped by, the engageable member easily and with certainty merely by a work of pushing the engageable member into the cover member while the engageable member is displaced toward the center of the electric cable insertion hole in the radial direction thereof.

This will be described in more detail. The housing is inserted into the cover member in order to attach the cover member to the housing. In this step, the engageable member is pushed into the cover member while being displaced toward the center of the electric cable insertion hole in the radial direction. In this manner, the housing is inserted into the cover member. The engageable member inserted into the cover member goes beyond the edge of the cover member. At this point, the engageable member is released from the pressing force of the cover member and returns to the original shape thereof. As a result, the edge of the cover member is engaged with, and stopped by, the engageable member. Then, the electric cable is inserted into the electric cable insertion hole while the edge of the cover member is engaged with, and stopped by, the engageable member, so that the engageable member is put into a locked state in which the engageable member is restricted from being displaced.

In an embodiment of the present invention, the engageable member may include an inclined part which is inclined, from a tip thereof to the opposite end thereof, in a direction opposite to the direction in which the engageable member is displaceable.

According to the above, during the work of inserting the housing into the cover member, the engageable member is pressed along the inclined part without any external force being applied toward the center of the electric cable insertion hole in the radial direction. As a result, the engageable member is displaced toward the center of the electric cable insertion hole. This simplifies the work of attaching the cover member to the housing.

In an embodiment of the present invention, the housing may include a plurality of the electric cable insertion holes for allowing a plurality of the electric cables to be inserted thereinto; the engageable member may have a width which is substantially the same as a distance between centers of two outer electric cable insertion holes among the plurality of electric cable insertion holes; and the engageable member may include ribs provided in positional correspondence with the plurality of electric cables, the ribs being each provided for connecting a part of the engageable member that is contactable with the corresponding electric cable and a part of the engageable member that is contactable with the edge of the cover member to each other.

According to the above, the engageable member has a width which is substantially the same as the distance between the centers of the two outer electric cable insertion holes among the plurality of electric cable insertion holes. This allows the edge of the cover member to be stopped over a larger width. Therefore, the relative positions of the housing and the cover member are restricted more stably. The vertical ribs are provided in positional correspondence with the electric cables. Owing to the vertical ribs, the engageable member can firmly receive the pressing force applied from the electric cables and the edge of the cover member; namely, the engageable member is made more durable.

In an embodiment of the present invention, at least one pair of the position restriction means may be provided so as to hold the electric cable(s) therebetween.

According to the above, the cover member can be stopped by the engageable members at symmetrical positions. This allows the relative positions of the housing and the cover member to be restricted with good balance.

### Advantageous Effects of Invention

The present invention provides a connector which can be assembled with certainty with a simple structure while having a reduced number of components, and a connector connection structure including the same.

### BRIEF DESCRIPTION OF DRAWINGS

FIG. 1 is an isometric view of a connector in an embodiment according to the present invention as seen from one of two ends thereof.

FIG. 2 is an isometric view of the connector as seen from the other end thereof.

FIG. 3 is an exploded isometric view of the connector that shows a housing and a metal cover.

FIG. 4 is a rear view of the housing, which is a view as seen from the other end of the connector.

FIG. 5 is a vertical cross-sectional view of the connector.

FIG. 6 is a horizontal cross-sectional view of the connector.

FIGS. 7A and 7B show how to assemble the connector and connect electric cables to the connector.

FIGS. 8A and 8B show how to assemble the connector and connect the electric cables to the connector.

### DESCRIPTION OF EMBODIMENTS

Hereinafter, an embodiment of the present invention will be described with reference to the drawings.

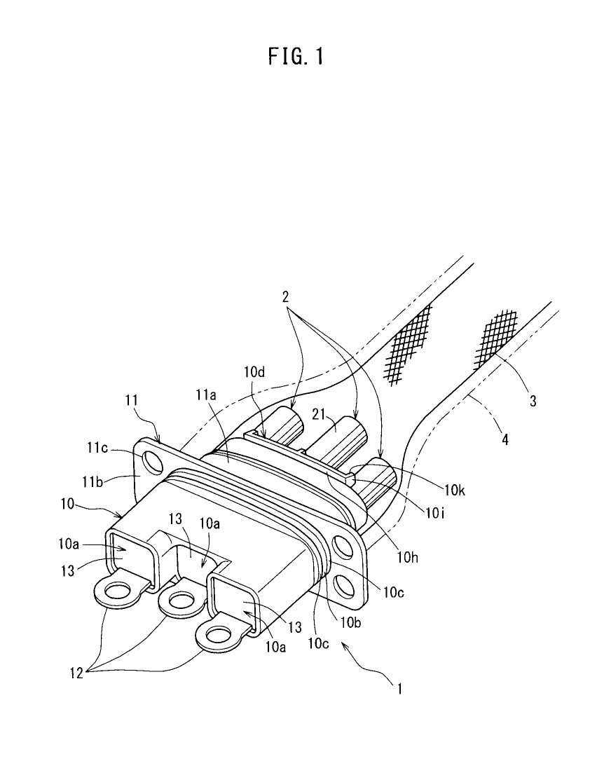

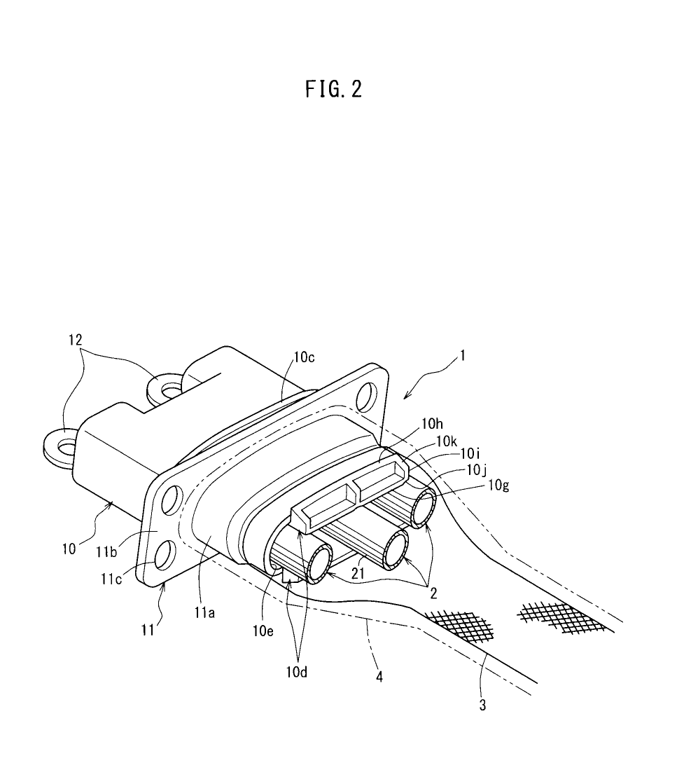

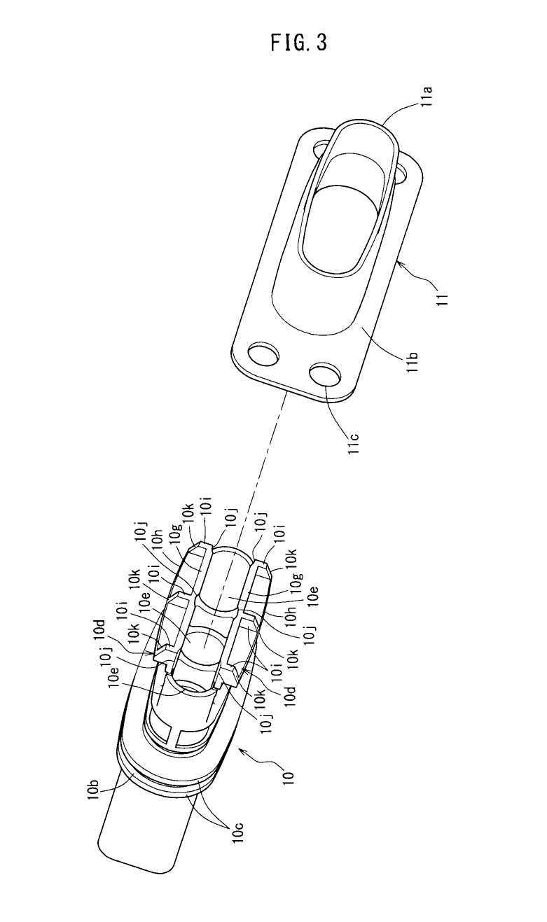

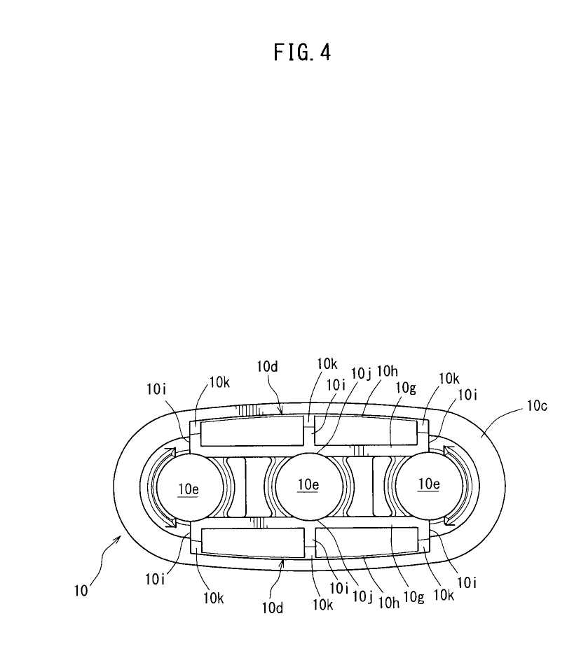

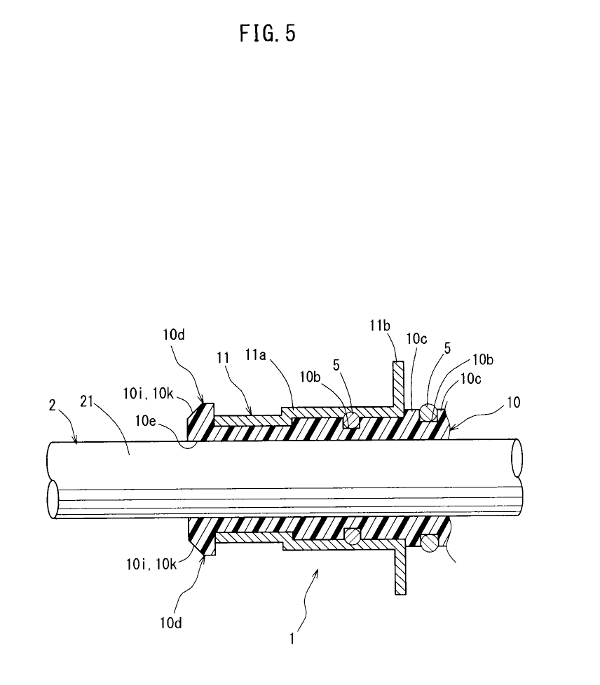

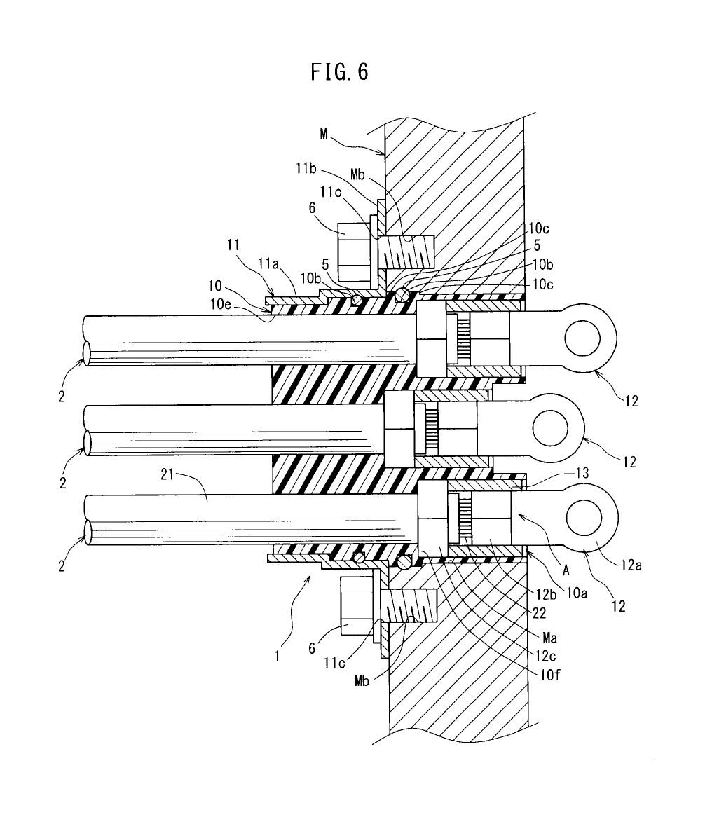

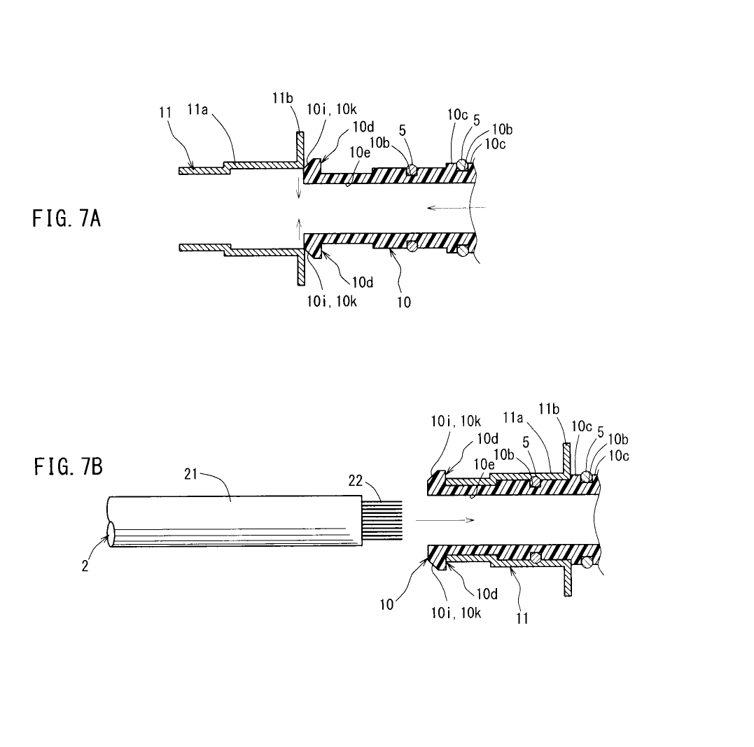

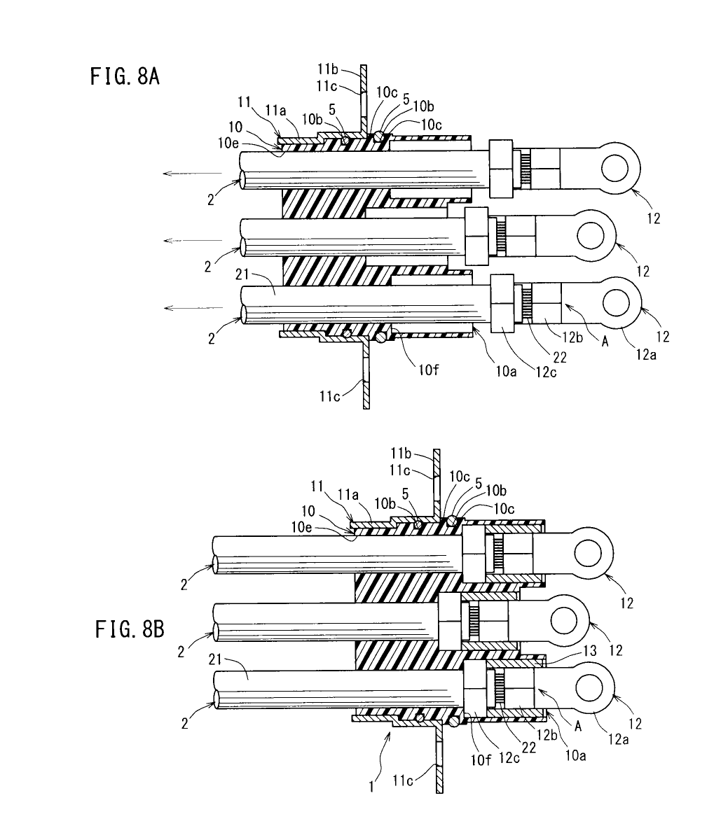

FIG. 1 is an isometric view of a connector 1 as seen from one of two ends thereof, and FIG. 2 is an isometric view of the connector 1 as seen from the other end thereof. FIG. 3 is an exploded isometric view of the connector 1 that shows a housing 10 and a metal cover 11. FIG. 4 is a rear view of the housing 10, which is a view as seen from the other end of the connector 1. FIG. 5 is a vertical cross-sectional view of the connector 1, and FIG. 6 is a horizontal cross-sectional view thereof. FIGS. 7A-7B and FIGS. 8A-8B show how to assemble the connector 1 and connect electric cables 2 to the connector 1. In this specification, the end of various components of the connector 1 on the side of metal terminal parts 12 is defined as the “one end”. The opposite end, namely, the end of various components of the connector 1 on the side of the electric cables 2 is defined as the “other end”. In FIG. 1 and FIG. 2, a boot 4 is shown as being transparent with two-dot chain line for the sake of convenience.

As shown in FIG. 1 through FIG. 6, the connector 1 includes the housing 10 which is formed of a resin and is flexible, the metal cover 11 which is tube-like and covers the housing 10, the plurality of (herein, three) metal terminal parts 12 exposed outside from one end of the housing 10, and a filler 13 provided to fill a plurality of (herein, three) filling spaces 10a formed at the one end of the housing 10. The filling spaces 10a correspond to the plurality of metal terminal parts 12 and are separate from each other.

As shown in FIG. 1, FIG. 2, FIG. 5 and FIG. 6, a plurality of (herein, three) the electric cables 2 are connected to the connector 1. As described later, each of the electric cables 2 has an end thereof pressure-contacted on the corresponding metal terminal part 12 of the connector 1. Outside the connector 1, as shown in FIG. 1 and FIG. 2, the electric cables 2 are covered with a shield braid 3 and the boot 4. The shield braid 3 is formed by braiding raw metal lines or metal-plated resin lines into a tube shape. The boot 4 is formed of a resin and is shown with the two-dot chain line in the figures. In FIG. 3 through FIG. 6, the shield braid 3 and the boot 4 are omitted for the sake of convenience.

The shield braid 3 is an electromagnetic shield member for absorbing electromagnetic waves emitted from the electric cables 2 when, for example, the electric cables 2 are provided for supplying electricity of a large current and a high voltage. The shield braid 3 prevents the electromagnetic waves from being released outside.

The shield braid 3 has an end thereof located on an outer wall of the metal cover 11 and is fixed to the metal cover 11 by a prescribed, generally ring-shaped fixing member (not shown) formed in correspondence with the shape of the metal cover 11. The boot 4 is fixed to the metal cover 11 by a prescribed band member (not shown). The boot 4 covers the ends of the electric cables 2, the metal cover 11 and the shield braid 3.

Among the components of the connector 1, the housing 10 has the plurality of filling spaces 10a at the one end thereof. As shown in FIG. 5 and FIG. 6, the housing 10 also has grooves 10b, convexed parts 10, and a pair of engageable claws 10d at an outer wall thereof. Into the grooves 10b, O-rings 5 can be fit. The convexed parts 10c sandwich and form the grooves 10b. The pair of engageable claws 10d are provided to hold the electric cables 2 therebetween.

As shown in FIG. 3 through FIG. 6, the housing 10 has a plurality of (herein, three) electric cable insertion holes 10e therein in numerical correspondence with the electric cables 2. The electric cable insertion holes 10e allow the electric cables 2 to be inserted thereinto. The engageable claws 10d are provided at an end of the electric cable insertion holes 10e in a direction in which the electric cables 2 are insertable. The electric cable insertion holes 10e are in communication with the filling spaces 10a and run through the housing 10 up to the other end thereof, and have the same cross-sectional shape as that of the electric cables 2. Therefore, in the state where the electric cables 2 are inserted into the electric cable insertion holes 10e, an outer circumferential surface of an insulating cover 21 of each electric cable 2 is in contact with a wall of the corresponding electric cable insertion hole 10e with substantially no space. Owing to this, the electric cable 2 is restricted to be at a prescribed position inside the housing 10.

As shown in FIG. 6, the filling spaces 10a and the electric cable insertion holes 10e have different diameters from each other. The filling spaces 10a have a larger diameter than that of the electric cable insertion holes 10e. As a result, there is a step 10f between each filling space 10a and the corresponding electric cable insertion hole 10e.

As shown in FIG. 1 through FIG. 5, an end of each engageable claw 10d on the side of the other end of the housing 10 is a free end. Therefore, when the engageable claws 10d are pushed toward centers of the electric cable insertion holes 10e in a radial direction thereof in the state where the electric cables 2 are not in the electric cable insertion holes 10e, the engageable claws 10d are displaced toward the centers of the electric cable insertion holes 10e because of the flexibility of the housing 10.

The engageable claws 10d are each provided commonly for the plurality of electric cables 2 inserted into the electric cable insertion holes 10e, and each have a width which is substantially the same as the distance between the centers of the two outer electric cable insertion holes 10e. The engageable claws 10d each have an electric cable contact part 10g which extends in the direction in which the electric cables 2 are located side by side and contact edges of the electric cable insertion holes 10e, a metal cover contact part 10h standing perpendicularly from the electric cable contact part 10g and contacting an edge of the metal cover 11 on the side of the other end of the connector 1, and vertical ribs 10i for connecting the electric cable contact part 10g and the metal cover contact part 10h to each other.

As shown especially in FIG. 2 through FIG. 4, the electric cable contact part 10g has electric cable contact parts 10j in positional correspondence with the electric cables 2. Owing to this, each engageable claw 10d can contact, with no gap, the electric cables 2 inserted into the electric cable insertion holes 10e.

A plurality of (herein, three) the vertical ribs 10i are provided in positional correspondence with the electric cables 2. The vertical ribs 10i each have an inclined part 10k which is inclined, from a tip thereof to the opposite end thereof, in a direction opposite to the direction in which the engageable claw 10d is displaceable.

The metal cover 11 includes a tube-like part 11a having a generally elliptical cross-section and a generally rectangular flange 11b standing perpendicularly from one end of the tube-like part 11a. The flange 11b has bolt holes 11c through which bolts 6 (see FIG. 6) are insertable. The bolt holes 11c are formed at four corners of the flange 11b.

In the connector 1, the flange 11d of the metal cover 11 is in contact with one of the convexed parts 10c of the housing 10, and thus one end of the metal cover 11 is positionally restricted. In addition, an edge of the other end of the tube-like part 11a of the metal cover 11 is engaged with, and stopped by, the engageable claws 10d, and thus the other end of the metal cover 11 is positionally restricted. In this manner, the one end and the other end of the metal cover 11 are positionally restricted by the convexed part 10c and the engageable claws 10d, so that the relative positions of the housing 10 and the metal cover 11 are restricted.

The electric cable contact parts 10j of the engageable claws 10d are in contact, with no gap, with the electric cables 2, which are positionally restricted by the electric cable insertion holes 10e, so that the engageable claws 10d are restricted from being displaced toward the centers of the electric cable insertion holes 10e in the radial direction. In this manner, the displacement of the engageable claws 10d is restricted by the electric cables 2, so that the engageable claws 10d are kept engaged with the metal cover 11 by the electric cables 2.

As shown in FIG. 6, the metal terminal parts 12 each include a connection terminal part 12a, a wire barrel 12b and an insulation barrel 12c, which are integrally formed together. The electric cables 2 are each stripped of the insulating cover 21 at the end thereof to expose conductive wires 22. In the connector 1, each insulating cover 21 at the end is pressure-contacted on the insulation barrel 12c by caulking, and the exposed conductive wires 22 are pressure-contacted on the wire barrel 12b by caulking. In this manner, the insulating covers 21 and the conductive wires 22 are pressure-contacted by caulking, so that the ends of the electric cables 2 are pressure-contacted on the metal terminal parts 12.

In the connector 1, the filling spaces 10a are located in positional correspondence with pressure-contact parts A (see FIG. 6) at which the ends of the electric cables 2 are pressure-contacted on the metal terminal parts 12. Owing to this, the pressure-contact parts A are accommodated in the housing 10. Each filling space 10a is filled with the filler 13 such that the filler 13 covers the pressure-contact part A. Materials usable as the filler 13 include, for example, an epoxy resin, an acrylic resin and silicone.

As shown in FIG. 6, in the housing 10, the filling spaces 10a each have substantially the same diameter as that of the insulating barrel 12c. Owing to this, the insulating barrel 12c is fit to the step 10f with no gap.

The connector 1 is used to connect the electric cables 2 for supplying electricity of a large current and a high voltage to an electric device M (see FIG. 6) such as, for example, a motor mounted on an electric vehicle. A chassis of the electric device M shown in FIG. 6 has an insertion opening Ma, and bolt holes Mb. In this case, as shown in FIG. 6, the connector 1 is inserted into the insertion opening Ma, and the bolts 6 are inserted into the bolt holes 11c of the metal cover 11 and the bolt holes Mb of the electric device M to tighten the connector 1 and the electric device M to each other. Thus, the electric device M and the electric cables 2 are connected to each other.

Now, steps for assembling the connector 1 and connecting the electric cables 2 to the connector 1 will be described.

First as shown in FIG. 7A, the metal cover 11 is attached to the housing 10. In the step shown in FIG. 7A, the other end of the housing 10 is inserted into the metal cover 11 from the one end of the metal cover 11. In this step, when it is attempted to insert the engageable claws 10d located at the other end of the housing 10 into the metal cover 11, the inclined parts 10k of the vertical ribs 10i contact an edge of the one end of the metal cover 11. When it is further attempted to insert the housing 10 into the metal housing 11, the engageable claws 10d are pressed along the inclined parts 10k. As a result, as represented with the thick arrows in the figure, the engageable claws 10d are displaced toward the centers of the electric cable insertion holes 10e. Owing to this, the housing 10 is inserted into the metal cover 11.

The engageable claws 10d inserted into the metal cover 11 reach the other end of the metal cover 11 and go beyond the edge of the other end of the metal cover 11. At this point, the engageable claws 10d are released from the pressing force of the metal cover 11 and returns to the original shape thereof. As a result, as shown in FIG. 7B, the engageable claws 10d are engaged with, and stop, the edge of the other end of the metal cover 11. The engageable claws 10d and the concaved part 10c at the one end of the housing 10 restrict the relative positions of the housing 10 and the metal cover 11. Thus, the attachment of the metal cover 11 to the housing 10 is finished.

Next, in the step shown in FIG. 7B, each electric cable 2 stripped of the insulating cover 21 to expose the conductive wires 22 is inserted into the electric cable insertion hole 10e of the housing 10. In this step, as shown in FIG. 7B, the end of the electric cable 2 is inserted into the electric cable insertion hole 10e from the other end of the housing 10. The electric cables 2 are inserted into the electric cable insertion holes 10e of the housing 10 in this manner, so that the displacement of the engageable claws 10d is restricted by the electric cables 2. As a result, the engageable claws 10d are kept engaged with the metal cover 11 by the electric cables 2.

Next, in the step shown in FIG. 8A, the ends of the electric cables 2 are pressure-contacted on the metal terminal parts 12. In this step, as shown in FIG. 8A, the ends of the electric cables 2 inserted into the electric cable insertion holes 10e are pulled outside from the one end of the housing 10, and the conductive wires 22 at the ends and the insulating covers 21 are respectively pressure-contacted on the wire barrels 12b and the insulation barrels 12c by caulking.

After the electric cables 2 are pressure-contacted on the metal terminal parts 12, the electric cables 2 are pulled in a direction toward the other end of the connector 1 as represented with the thick arrows until the insulation barrels 12c contact the steps 10f of the housing 10. The insulation barrels 12c are put into contact with the steps 10f, so that the position of the electric cables 2 in the direction in which the electric cables 2 are insertable is restricted, and also the positions of the pressure-contact parts A in the filling spaces 10a of the housing 10 are determined.

In the step shown in FIG. 8B, the filling spaces 10a are filled with the filler 13 such that the filler 13 covers the pressure-contact parts A. In this manner, the steps shown in FIGS. 7 and 8 are performed, and thus the connector 1 having the ends of the electric cables 2 pressure-contacted on the metal terminal parts 12 is completed.

As described above, in this embodiment, the connector 1 includes the tube-like metal cover 11 for covering the housing 10. In addition, the engageable claws 10d which are restricted, by the electric cables 2 inserted into the electric cable insertion holes 10e, from being displaced restrict the relative positions of the housing 10 and the metal cover 11. Thus, the connector 1 can be assembled with certainty with a simple structure while the number of components thereof is reduced.

This will be described in more detail. The metal cover 11, which is tube-like, can be formed of a single component. This decreases the number of components of the connector 1. In addition, the electric cables 2 inserted into the electric cable insertion holes 10e are used to restrict the engageable claws 10 from being displaced. Therefore, the relative positions of the housing 10 and the metal cover 11 are restricted with no use of any additional bolt or the like. This decreases the number of components of the connector 1, and also makes the troublesome work of bolt tightening or the like unnecessary. Therefore, the connector 1 can be assembled with certainty with a simple structure.

The electric cable insertion holes 10e are put into contact with the outer circumferential surfaces of the insulating covers 21 of the electric cables 2, and the electric cables 2 are in contact with the walls of the electric cable insertion holes 10e with substantially no space. This allows the electric cables 2 to restrict, with more certainty, the engageable claws 10d from being displaced.

The housing 10 is formed of a resin. The engageable claws 10d integrally formed in the housing 10 are located at the ends of the electric cable insertion holes 10e from which the electric cables 2 are inserted, and are displaceable toward the centers of the electric cable insertion holes 10e in the radial direction. Owing to this, the edge of the other end of the metal cover 11 can be put into engagement with, and stopped by, the engageable claws 10d easily and with certainty merely by a work of pushing the engageable claws 10d into the metal cover 11 while the engageable claws 10d are displaced toward the centers of the electric cable insertion holes 10e.

This will be described in more detail. The housing 10 is inserted into the metal cover 11 in order to attach the metal cover 11 to the housing 10. In this step, the engageable claws 10d are pushed into the metal cover 11 while being displaced toward the centers of the electric cable insertion holes 10e in the radial direction. In this manner, the housing 10 is inserted into the metal cover 11. The engageable claws 10d inserted into the metal cover 11 go beyond the edge of the other end of the metal cover 11. At this point, the engageable claws 10d are released from the pressing force of the metal cover 11 and returns to the original shape thereof. As a result, the edge of the other end of the metal cover 11 is engaged with, and stopped by, the engageable claws 10d. Then, the electric cables 2 are inserted into the electric cable insertion holes 10e while the edge of the other end of the metal cover 11 is engaged with, and stopped by, the engageable claws 10d, so that the engageable claws 10e are put into a locked state in which the engageable claws 10e are restricted from being displaced.

The engageable claws 10d have the inclined parts 10k which are each inclined, from a tip thereof to the opposite end thereof, in a direction opposite to the direction in which the engageable claw 10d is displaceable. Owing to this, during the work of inserting the housing 10 into the metal cover 11, the engageable claws 10d are pressed along the inclined parts 10k without any external force being applied toward the centers of the electric cable insertion holes 10e in the radial direction. As a result, the engageable claws 10d are displaced toward the centers of the electric cable insertion holes 10e. This simplifies the work of attaching the metal cover 11 to the housing 10.

The engageable claws 10d each have a width which is substantially the same as the distance between the centers of the two outer electric cable insertion holes 10e. This allows the edge of the other end of the metal cover 11 to be stopped over a larger width. Therefore, the relative positions of the housing 10 and the metal cover 11 are restricted more stably. The vertical ribs 10i for connecting the electric cable contact part 10g and the metal cover contact part 10h to each other are provided in positional correspondence with the electric cables 2. Owing to the vertical ribs 10i, the engageable claws 10d can firmly receive the pressing force applied from the electric cables 2 and the edge of the other end of the metal cover 11; namely, the engageable claws 10d is made more durable.

The pair of engageable claws 10d are provided so as to hold the electric cables 2 therebetween. Owing to this, the metal cover 11 can be stopped by the engageable claws 10d at symmetrical positions. This allows the relative positions of the housing 10 and the metal cover 11 to be restricted with good balance.

In this embodiment, the connector 1 includes the electric cable insertion holes 10e, each defined by the wall with which the outer circumferential surface of the insulating cover 21 of each electric cable 2 is put into contact, and also includes the filling spaces 10a in communication with the electric cable insertion holes 10e. In addition, the filling spaces 10a are filled with the filler 13 such that the filler 13 covers the pressure-contact parts A. These arrangements simplify the structure of the connector 1.

This will be described in more detail. Since the filling spaces 10a accommodating the pressure-contact parts A are filled with the filler 13, the pressure-contact parts A are covered with certainty with no use of any molding method. In addition, the electric cable insertion holes 10e are put into contact with the outer circumferential surfaces of the insulating covers 21, and the electric cables 2 are in contact with the walls of the electric cable insertion holes 10e with substantially no gap. This restricts the positions of the electric cables 2 inserted into the electric cable insertion holes 10e, and thus restricts the positions of the pressure-contact parts A in the filling spaces 10a. In this case, the positions of the pressure-contact parts A are restricted with no need of any special component. This simplifies the structure of the connector 1.

The steps 10f are each formed between the filling space 10a and the electric cable insertion hole 10e, in correspondence with the difference between the diameter of the electric cable 2 and the diameter of the pressure-contact part A (herein, the diameter of the insulation barrel 12c, which has the largest diameter). Owing to this, the step 10f, formed because of the diameter difference between the electric cable 2 and the pressure-contact part A, is usable to determine the position of the pressure-contact part A in the direction in which the electric cable 2 is insertable, with no need of any special component. Therefore, the position of the pressure-contact part A in the filling space 10a is restricted with more certainty while the structure of the connector 1 is simplified.

The housing 10 has the filling spaces 10a, which are provided in correspondence with the plurality of electric cable insertion holes 10e and are separate from each other. Owing to this, the pressure-contact parts A are covered with the filler 13 with certainty. This will be described in more detail. For example, it is conceivable to form one common filling space for accommodating the plurality of pressure-contact parts A. However, such a filling space has a complicated and enlarged structure, and thus involves an undesirable possibility that air bubbles are formed in a part of the filling space during the work of filling the filling space with the filler 13. By contrast, in the above-described structure in which the filling spaces 10 are formed separately in correspondence with the electric cable insertion holes 10e, each filling space 10a is simplified in shape and decreased in capacity. Therefore, the pressure-contact parts A are covered with the filler 13 with certainty with no air bubble being formed in the filling spaces 10a.

In the above-described embodiment, the engageable claws 10d are formed integrally in the housing 10 in order to restrict the relative positions of the housing 10 and the metal cover 11. The present invention is not limited to such a structure. For example, either one of the housing 10 and the metal cover 11 may have a groove or a convexed part, whereas the other of the housing 10 and the metal cover 11 may have a convexed part or a groove engageable with the groove or the convexed part.

In the above-described embodiment, the pair of engageable claws 10d are provided so as to hold the electric cables 2 therebetween. The present invention is not limited to such a structure. For example, a pair of engageable claws (engageable members) facing each other in a direction perpendicular to the direction in which the engageable claws 10d face each other may be additionally provided. Alternatively, a plurality of engageable members (engageable claws) may be provided on the edge of the other end of the housing 10 at a prescribed interval in a circumferential direction thereof, with no limitation on the direction in which the engageable members are directed.

The cover member according to the present invention corresponds to the metal cover 11 in the above-described embodiment;

the position restriction means and the engageable member corresponds to the engageable claw 10d;

the part of the engageable member that is contactable with the electric cable corresponds to the electric cable contact part 10g; and

the part of the engageable member that is contactable with the cover member corresponds to the metal cover contact part 10h. However, the present invention is not limited to the above-described embodiment.

### REFERENCE SIGNS LIST

1 . . . Connector
2 . . . Electric cable
10 . . . Housing
10d . . . Engageable claw
10e . . . Electric cable insertion hole
10g . . . Electric cable contact part
10h . . . Metal cover contact part
10i . . . Vertical rib
10k . . . Inclined part
11 . . . Metal cover
12 . . . Metal terminal part
M . . . Electric device
Ma . . . Insertion opening

1. A connector for connecting an electric cable to an electric device having an insertion opening provided for electric cable connection, the connector comprising:
a metal terminal part on which conductive wires exposed outside at an end of the electric cable are pressure-contacted;
a housing for accommodating the end of the electric cable and the metal terminal part; and
a tube-like cover member for covering the housing and fixing the housing to the electric device;
wherein:
the housing has an electric cable insertion hole through which the electric cable is insertable; and
the housing includes position restriction means for restricting relative positions of the housing and the cover member, the position restriction means being restricted, by the electric cable inserted into the electric cable insertion hole, from being displaced.

2. A connector according to claim 1, wherein an outer circumferential surface of an insulting cover of the electric cable is in contact with a wall of the electric cable insertion hole.

3. A connector according to claim 1, wherein:
the housing is formed of a flexible resin;
the position restriction means is an engageable member integrally formed in the housing, the engageable member being engageable with, and stopping, an edge of the cover member to restrict the relative positions of the housing and the cover member;
the engageable member is provided at an end of the electric cable insertion hole in a direction in which the electric cable is insertable; and
the engageable member is displaceable toward a center of the electric cable insertion hole in a radial direction thereof.

4. A connector according to claim 3, wherein the engageable member includes an inclined part which is inclined, from a tip thereof to the opposite end thereof, in a direction opposite to the direction in which the engageable member is displaceable.

5. A connector according to claim 3, wherein:
the housing includes a plurality of the electric cable insertion holes for allowing a plurality of the electric cables to be inserted thereinto;
the engageable member has a width which is substantially the same as a distance between centers of two outer electric cable insertion holes among the plurality of electric cable insertion holes; and
the engageable member includes ribs provided in positional correspondence with the plurality of electric cables, the ribs being each provided for connecting a part of the engageable member that is contactable with the corresponding electric cable and a part of the engageable member that is contactable with the edge of the cover member to each other.

6. A connector according to claim 1, wherein at least one pair of the position restriction means are provided so as to hold the electric cable(s) therebetween.

7. A connector connection structure, comprising:
a connector according to claim 1; and
an insertion opening of an electric device;
wherein the connector is inserted into the insertion opening to connect the electric device and the electric cable(s) to each other.
